(19) United States
(12) Patent Application Publication
(10) Pub. No.: US 2017/0314904 A1
(43) Pub. Date: Nov. 2, 2017

(54) MARKING AND CUTTING TEMPLATE TOOL FOR SHEET MATERIALS

(71) Applicant: Robert S. Hudnall, Heathsville, VA (US)

(72) Inventor: Robert S. Hudnall, Heathsville, VA (US)

(21) Appl. No.: 15/496,222

(22) Filed: Apr. 25, 2017

Related U.S. Application Data
(60) Provisional application No. 62/330,418, filed on May 2, 2016.

(51) Int. Cl. G01B 3/56

(52) U.S. Cl. CPC G01B 3/566

(57) ABSTRACT

A marking and cutting template for sheet materials includes a main body having a face side and a back side opposing the face side. The main body is configured to be coupled to a portion of a T-square. A template body rotatably mounted in the main body includes at least one hole extending through the template body with the hole(s) being accessible at the face side and back side of the main body. A locking mechanism coupled to the main body can engage the template body such that the template body is prevented from rotating relative to the main body.

Pursuant to 35 U.S.C. §119, the benefit of priority from provisional application 62/330,418, with a filing date of May 2, 2016, is claimed for this non-provisional application.

### FIELD OF THE INVENTION

The invention relates generally to marking and cutting guides, and more particularly to a marking and cutting template tool for marking/cutting holes in sheet materials that are to be aligned with rectangular or round electrical boxes mounted on wall or ceiling studs.

### BACKGROUND OF THE INVENTION

During the rough-in phase of construction, a variety of electrical boxes are attached to wall and ceiling studs. Such electrical boxes are generally rectangular or round. Prior to attaching sheet materials (e.g., drywall, wainscoting, etc.) to wall and ceiling studs, workers pre-cut holes in the sheet materials in order to provide access to the various electrical boxes once the sheet materials are installed. Currently, holes are marked on sheet materials and then the marked holes are cut out. The whole process is tedious and is prone to plentiful human error. Sometimes the error results in holes that are partially exposed even after a trim plate is attached. Other times the holes are too far off and the whole piece of sheet material must be scrapped.

### SUMMARY OF THE INVENTION

Accordingly, it is an object of the present invention to provide a tool that can be used to accurately mark sheet materials for electrical box cutouts.

Another object of the present invention is to provide a tool that can be used as a sheet-material cutting guide for electrical box cutouts.

Still another object of the present invention is to provide a tool that can be used to accurately mark wall or ceiling sheet materials and/or used to accurately cut sheet materials for a variety of shapes and sizes of electrical box cutouts.

Other objects and advantages of the present invention will become more obvious hereinafter in the specification and drawings.

In accordance with the present invention, a marking and cutting template for sheet materials includes a main body having a face side and a back side opposing the face side. The main body is adapted to be coupled to a portion of a T-square. A template body is rotatably mounted in the main body. The template body includes at least one hole extending through the template body with the hole(s) being accessible at the face side of the main body and at the back side of the main body. A locking mechanism coupled to the main body can engage the template body such that the template body is prevented from rotating relative to the main body.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective view of a T-square-mounted template tool for marking and/or cutting holes in sheet materials in accordance with an embodiment of the present invention;

FIG. 2 is a plan view of the bottom of the template tool in accordance with an embodiment of the present invention;

FIG. 3 is an isolated perspective view of the template tool's rotating disk in accordance with an embodiment of the present invention;

FIG. 4 is a cross-sectional view of the rotating disk taken along line 4-4 in FIG. 3 and as positioned in the template tool's main body;

FIG. 5 is an end view of a portion of the template tool taken along line 5-5 in FIG. 1 showing one end of a guide sleeve for a T-square's tongue;

FIG. 6 is an end view of a portion of the template tool along line 6-6 in FIG. 1 showing another end of the guide sleeve for a T-square's tongue; and

FIG. 7 is a plan view of the template tool and a T-square mounted faceplate illustrating corresponding indexing marks in accordance with an embodiment of the present invention.

### DETAILED DESCRIPTION OF THE INVENTION

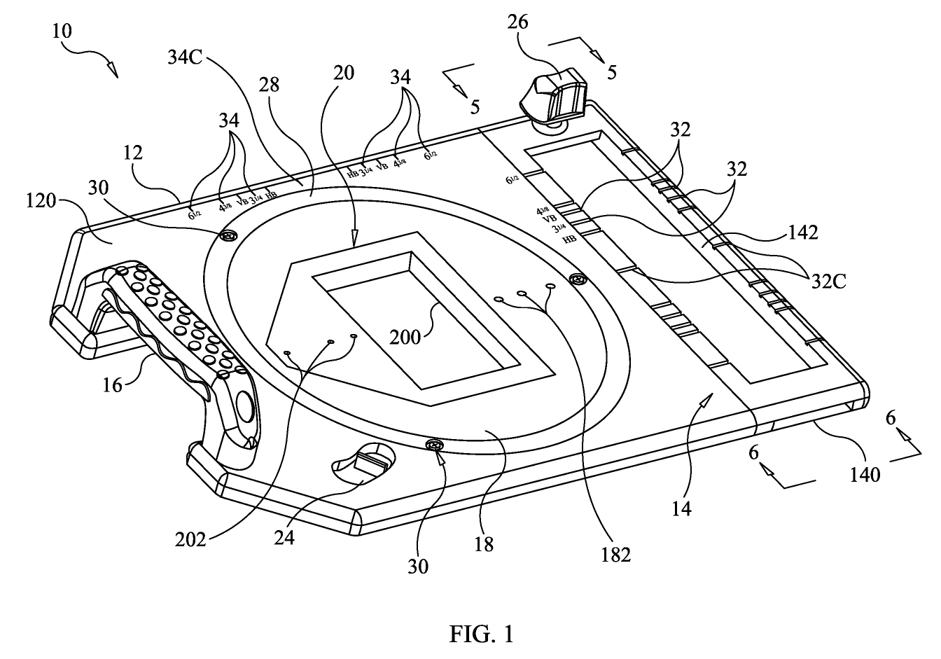

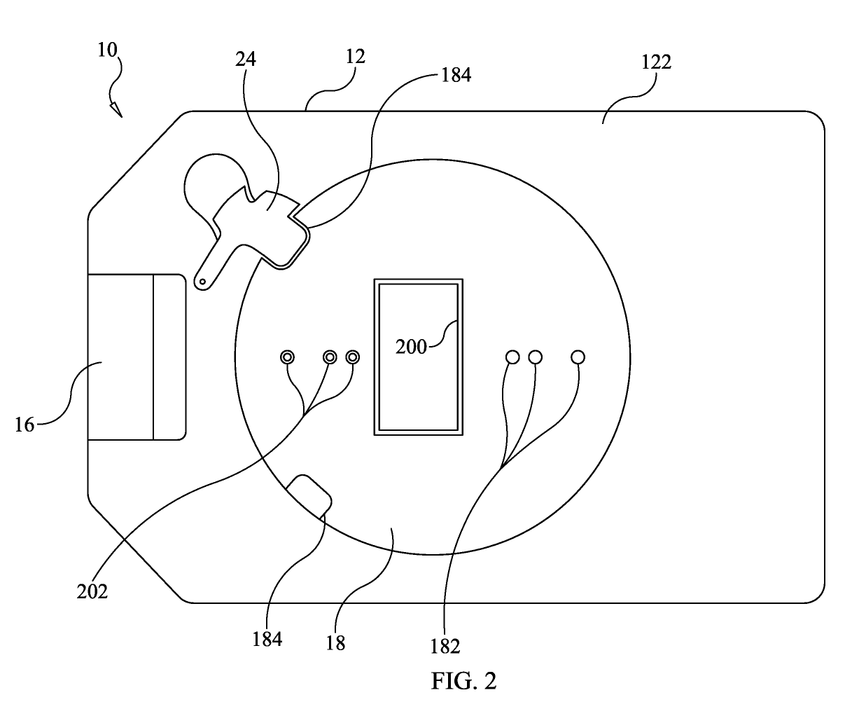

Referring now to the drawings and more particularly to FIG. 1, a marking and cutting template tool for sheet materials in accordance with an embodiment of the present invention is shown and is referenced generally by numeral 10. The term “sheet material” as used herein includes a variety of materials that can be attached to wall or ceiling studs such as, but not limited to, drywall, wainscoting, decorative metal or plastic sheets, and other sheet materials. As will be explained further below, when marking/cutting sheet materials prior to their installation, template tool 10 is mounted on a conventional T-square and is used to accurately mark and/or serve as a cutting guide for holes in sheet materials that need to be aligned with electrical boxes mounted on wall or ceiling studs. That is, template tool 10 can be used to accurately mark cut lines on sheet materials for subsequent cutting, or template tool 10 can be used as a cutting guide that remains in place as cutting tools are used in combination with template tool 10 to accurately cut holes in sheet materials without ever marking the sheet materials. In describing template tool 10, additional and simultaneous reference will be made to FIGS. 2-7 where various views of the present invention or its features are illustrated.

Template tool 10 includes a main body 12 having a T-square guide and mounting portion 14, a handle 16 coupled to main body 12 (e.g., in a fixed fashion, in a removable fashion, etc.), a disk 18 rotatably mounted to or in main body 12 adjacent to T-square guide and mounting portion 14, a marking/cutting template 20 incorporated into disk 18 for rotation therewith, marking holes 182 (e.g., cylindrical holes) in disk 18 sized to receive the barrel of a writing implement, and a disk lock 24 mounted in main body 12 for selective engagement with disk 18 to prevent rotation of disk 18. Materials used for the various elements of template tool 10 will generally be rigid and capable of withstanding rough construction environments and handling. As will be explained further below marking/cutting template 20 is generally made from a material (e.g., metal, composite, etc.) that can retain its structural integrity even if/when power tool bits and/or blades brush against template 20 during use.

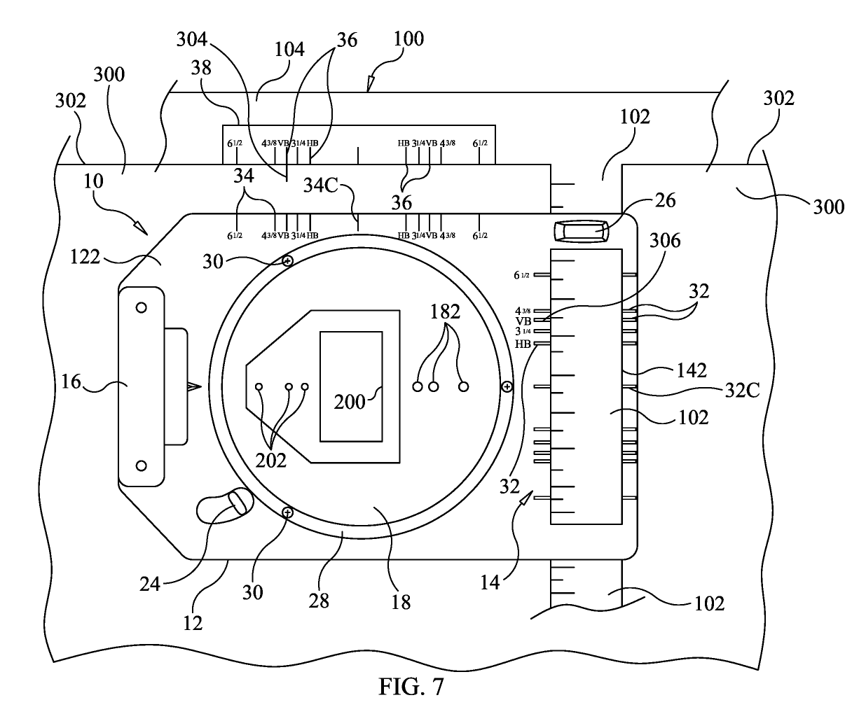

Main body 12 includes a face side 120 (FIGS. 1 and 6) and an opposing planar back side (FIG. 2) to allow template tool 10 to lie flat against a face of a sheet material. At face side 120, main body 12 provides support for gripping handle 16 (or more than one gripping handle) that can be attached to main body 12 or integrated therewith without departing from the scope of the present invention. Coupled to or integrated with main body 12 at face side 120 is T-square guide and mounting portion 14 that essentially defines a sleeve for the tongue portion 102 of a conventional T-square 100 as shown in FIG. 7. By way of a non-limiting illustrative example and with reference to FIGS. 5 and 6, portion 14 essentially defines an open-ended sleeve 140 for receiving the T-square's tongue 102 and for fixing template tool 10 to tongue 102. One open end of sleeve 140 is on one side of template tool 10 (FIG. 5) and the other open end of sleeve 140 is on the opposing side of template tool 10 (FIG. 6). A set screw 26 threaded in main body 12 can be used to apply pressure to a T-square's tongue 102 to thereby fix template tool 10 to the T-square. However, it is to be understood that other types of holding/gripping structures can be used to hold the T-square in place without departing from the scope of the present invention. Portion 14 also defines a rectangular window 142 at face side 120 through which measurement markings on tongue 102 are visible from face side 120.

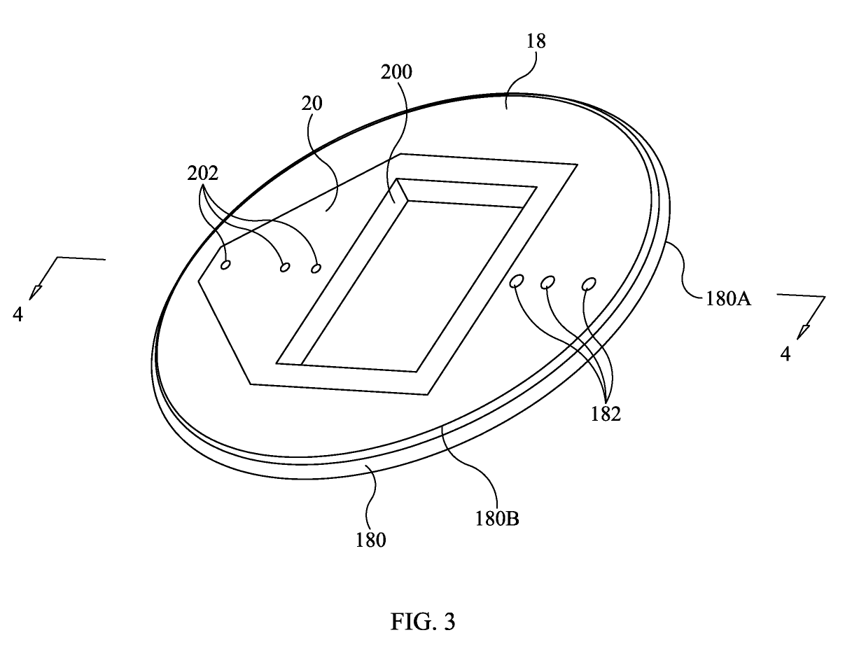

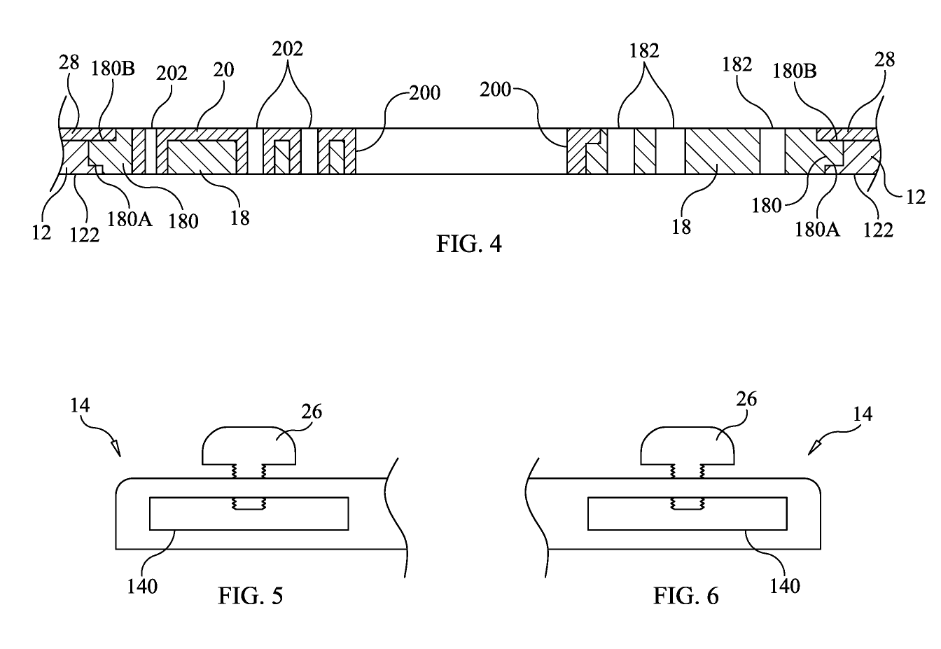

Disk 18, with template 20 coupled to or integrated with disk 18, is rotatably mounted on or in main body 12 with the user portion thereof accessible from face side 120. A variety of rotatable mounting schemes for disk 18 can be used without departing from the scope of the present invention. By way of an illustrative example, disk 18 can have an annular lip 180 (FIGS. 3 and 4) with a lower face 180A of lip 180 providing a bearing surface that will bear against an annular ledge or flange 124 (FIG. 4) in main body 12. When disk 18 is placed in main body 12 from face side 120, a retaining ring 28 can be used to bear against an upper face 180B of lip 180 to capture disk 18 in main body 12. Retaining ring 28 can be held in place by screws 30 cooperating with main body 12. As would be understood in the art, bearings and/or other materials or structures can be included and/or used to facilitate the rotation of disk 18 relative to main body 12 and retaining ring 28 without departing from the scope of the present invention.

Incorporated into or integrated with disk 18 is marking/cutting template 20. Disk 18 and template 20 can be made from the same or different materials, and/or can be assembled or of one-piece construction without departing from the scope of the present invention. As mentioned above, template 20 is constructed to withstand scrapes by rotating, oscillating, or vibrating power tool bits or blades so that template 20 can be used as a cutting guide for direct cutting of holes in sheet materials. Referring additionally to the bottom plan view shown in FIG. 2, template 20 includes a rectangular opening 200 and one or more drill/cutting bit holes 202 (e.g., cylindrical holes) that can extend partially or all the way through disk 18 (as shown) such that opening 200 and bit holes 202 are accessible at face side 120 and back side 122 of main body 12. Rectangular opening 200 is used to mark/cut rectangular holes in sheet materials to accommodate single, double, triple, etc., rough-in boxes. Each of bit holes 202 is associated with a specific hole diameter that is to be cut. When marking or cutting a round hole, disk 18 is allowed to rotate relative to main body 12. In addition, marking holes 182 can be provided in another portion of disk 18 and accessible from face side 120 and back side 122 of main body 12 so that a pencil/pen (not shown) can be positioned in and through one of holes 182. Then, as disk 18 is rotated, the writing tip of the inserted pencil/pen marks a round hole on sheet materials. Holes 182 can be larger than bit holes 202 to accommodate standard writing utensils whose diameters are generally larger than that of a power tool's bit. The provision of multiple holes 182 and/or holes 202 can also be realized using a movable template (not shown) mounted in disk 18 where a single hole provided in the movable template would allow a user to position the holes in a variety of positions for marking and/or drill holes. Furthermore, rectangular opening 200 and bit holes 202 can be configured/sized to accept or cooperate with a blade or bit guide to prevent a blade or bit from contacting template tool 10 during cutting or drilling operations.

As mentioned above, rectangular opening 200 is used to mark/cut rectangularly-shaped holes. Since rectangular holes are typically oriented in either a “portrait” or “landscape” orientation, disk 18 can be locked such that rectangular opening 200 is in one of two orientations. An example of a locking mechanism is a disk lock 24 accessible by a user from face side 120 of main body 12. At back side 122, disk lock 24 engages one of two locking recesses 184 defined in the bottom of disk 18 as shown in FIG. 2. Recesses 184 are located 90° apart to support the perpendicular relationship between a portrait hole orientation and a landscape hole orientation. Additional locking recesses can be provided to define additional orientations of opening 200 without departing from the scope of the present invention. Other types of locking mechanisms can be used without departing from the scope of the present invention. From face side 120 of main body 12, disk lock 24 is manually disengaged from a recess 184 in disk 18 when disk rotation is needed to mark or cut a round hole.

In FIG. 7, template tool 10 is shown fixed to the tongue 102 of T-square 100 as explained above. A number of markings 32 are provided on portion 14 adjacent to its window 142 for alignment with measurement markings on tongue 102. A similar set of markings 34 can be provided along an edge of main body 12 that opposes the head 104 of T-square 100. The center marking 32C of markings 32 and the center marking 34C of markings 34 is aligned with the center of disk 18. The edge of window 142 with markings 32 and the edge of main body 12 with markings 34 are perpendicular to one another. Head 104 of T-square 100 bears against an edge 302 of a piece of sheet material 300. A similar set of markings 36 are provided on a faceplate 38 coupled to the head 104 of T-square 100 where markings 36 oppose markings 34 on main body 12. Markings 32, 34 and 36 refer to rectangular box orientations (i.e., “VB” is for a vertically oriented box, “HB” is for a horizontally oriented box) and hole diameter sizes (e.g., 3¼, 4⅜, 6½). Markings 32, 34 and 36 can also be color coded for easy recognition.

In order to mark or cut out a rectangular hole such as a standard single-box hole in a portrait or vertical orientation, only two measurements at a stud wall are needed. The first measurement is taken along the horizontal plane to either side of the electrical box, and the first measurement is referenced with a mark 304 along the edge 302 of sheet material 300 to be marked/cut. The second measurement is taken to either side of the box along the vertical plane, and the second measurement governs the movement of template tool on tongue 102 of T-square 100 to the corresponding mark 306 of markings 32 (e.g., “VB” in the illustrated example) on template tool 10 along tongue 102. Once template tool 10 is set on tongue 102, the reference mark 304 on the sheet material's edge 302 is aligned with the corresponding marking 36 (e.g., “VB” in the illustrated example) on T-square head 104. As a result, the box location is quickly, easily, and correctly placed within the field of sheet material 300 where the box location is ready to be marked or cut.

The marking or cutting of multi-gang boxes can be achieved using template tool 10 by additionally measuring along the horizontal plane to both the left and right sides of the box, referencing these measurements accordingly, and marking both along the edge of the sheet material. Again, a single measurement is taken along the vertical plane to either top or bottom of the box. Template tool 10 is set to the corresponding mark along the T-square's tongue for the vertical measurement. Then, using the reference marks on the T-square for both the left and right side of the single gang template, the T-square is moved/slid the required distance along the piece of sheet material when marking and or cutting in order enlarge the opening to the desired size.

The marking or cutting of round hole cuts is accomplished in the same manner as with the single gang box. That is, single horizontal and vertical measurements are taken to the edge of the roughed-in round box. The measurements are then referenced in the same manner as discussed above one along the edge of the sheet material and the other is set correspondingly along the tongue of the T-square. The template tool's rotatable disc 18 is unlocked and the T-square is aligned (using the corresponding hole size) to the reference mark on the edge of the sheet material. This places the template tool properly in the field of the sheet material for the hole location. The proper hole 182 or 202 is then selected for the desired hole size and a pencil or drilling/cutting bit is inserted into hole 182 or 202, respectively. Disk 18 is then rotated to guide the marking or hole cutting within the wall covering.

Although the invention has been described relative to specific embodiments thereof, there are numerous variations and modifications that will be readily apparent to those skilled in the art in light of the above teachings. For example, the template tool could be used in a “stand alone” fashion without a T-square in cases where existing sheet materials must be marked/cut for a retrofit installation of an electrical outlet, light switch, recessed light, ceiling fan, etc. A bubble level could also be incorporated into the template tool's main body. Still further, marking holes 182 and/or bit holes 202 could be provided in slidable portion(s) of template 20 thereby providing greater flexibility in defining the diameter of a round hole to be marked or cut. The number of markings provided on the template tool and accompanying faceplate can be more, less, and/or different from the markings shown without departing from the scope of the present invention. Additional rotating disks with different patterns/sizes of holes could be provided to increase the flexibility of the tool. It is therefore to be understood that, within the scope of the appended claims, the invention may be practiced other than as specifically described.

What is claimed as new and desired to be secured by Letters Patent of the United States is:

1. A marking and cutting template, comprising:
a main body having a face side and a back side opposing said face side, said main body adapted to be coupled to a portion of a T-square;
a template body rotatably mounted in said main body, said template body including at least one hole extending through said template body wherein said at least one hole is accessible at said face side of said main body and at said back side of said main body; and
a locking mechanism coupled to said main body for engaging said template body wherein said template body is prevented from rotating relative to said main body.

2. A marking and cutting template as in claim 1, wherein said at least one hole includes a rectangular hole and at least one additional hole.

3. A marking and cutting template as in claim 2, wherein said at least one additional hole comprises a plurality of cylindrical holes.

4. A marking and cutting template as in claim 1, wherein said main body includes a sleeve adapted to receive the portion of the T-square, and wherein a window in said face side of said main body is aligned with said sleeve wherein the T-square is visible from said face side through said window.

5. A marking and cutting template as in claim 1, further comprising a handle coupled to said face side of said main body.

6. A marking and cutting template as in claim 1, wherein said back side is planar.

7. A marking and cutting template as in claim 4, further comprising:
first measurement markings on said face side of said main body along an edge of said window; and
second measurement markings on said face side of said main body along an edge of said main body wherein said edge of said window and said edge of said main body are perpendicular to one another.

8. A marking and cutting template as in claim 7, further comprising a faceplate having third measurement markings, said faceplate adapted to be coupled to the T-square wherein said third measurement markings oppose said second measurement markings on said main body when the T-square is coupled to the main body.

9. A marking and cutting template, comprising:
a main body having a face side and a back side opposing said face side, said main body adapted to be coupled to a portion of a T-square, said main body including a sleeve adapted to receive the portion of the T-square through said sleeve, said main body further including a window in said face side of said main body aligned with said sleeve wherein the T-square is visible from said face side through said window;
a template body rotatably mounted in said main body adjacent to said sleeve, said template body including at least one hole extending through said template body wherein said at least one hole is accessible at said face side of said main body and at said back side of said main body; and
a locking mechanism coupled to said main body for engaging said template body wherein said template body is prevented from rotating relative to said main body.

10. A marking and cutting template as in claim 9, wherein said at least one hole includes a rectangular hole and at least one additional hole.

11. A marking and cutting template as in claim 10, wherein said at least one additional hole comprises a plurality of cylindrical holes.

12. A marking and cutting template as in claim 9, further comprising a handle coupled to said face side of said main body.

13. A marking and cutting template as in claim 9, wherein said back side is planar.

14. A marking and cutting template as in claim 9, further comprising:
first measurement markings on said face side of said main body along an edge of said window; and
second measurement markings on said face side of said main body along an edge of said main body wherein said edge of said window and said edge of said main body are perpendicular to one another.

15. A marking and cutting template as in claim 14, further comprising a faceplate having third measurement markings, said faceplate adapted to be coupled to the T-square wherein said third measurement markings oppose said second measurement markings on said main body when the T-square is coupled to the main body.

16. A marking and cutting template, comprising:
a main body having a face side and a planar back side opposing said face side, said main body adapted to be coupled to a portion of a T-square, said main body including a sleeve adapted to receive the portion of the T-square through said sleeve, said main body further including a window in said face side of said main body aligned with said sleeve wherein the T-square is visible from said face side through said window;
first measurement markings on said face side of said main body along an edge of said window;
second measurement markings on said face side of said main body along an edge of said main body wherein said edge of said window and said edge of said main body are perpendicular to one another;
a template body rotatably mounted in said main body, said template body including at least one hole extending through said template body wherein said at least one hole is accessible at said face side of said main body and at said back side of said main body; and
a locking mechanism coupled to said main body for engaging said template body wherein said template body is prevented from rotating relative to said main body.

17. A marking and cutting template as in claim 16, wherein said at least one hole includes a rectangular hole and at least one additional hole.

18. A marking and cutting template as in claim 17, wherein said at least one additional hole comprises a plurality of cylindrical holes.

19. A marking and cutting template as in claim 17, further comprising a handle coupled to said face side of said main body.

20. A marking and cutting template as in claim 16, further comprising a faceplate having third measurement markings, said faceplate adapted to be coupled to the T-square wherein said third measurement markings oppose said second measurement markings on said main body when the T-square is coupled to the main body.
